(19) United States
(12) Patent Application Publication
(10) Pub. No.: US 2007/0000747 A1
(43) Pub. Date: Jan. 4, 2007

(54) Wet clutch friction plate and multiple disc friction clutch apparatus

(76) Inventor: Tomoyuki Miyazaki, Kakegawa-shi (JP)

Correspondence Address: MILES & STOCKBRIDGE PC, 1751 PINNACLE DRIVE, SUITE 500, MCLEAN, VA, 22102-3833, US

(21) Appl. No.: 11/474,943

(22) Filed: Jun. 27, 2006

(30) Foreign Application Priority Data
Jun. 28, 2005 (JP) 2005-188869
Jun. 28, 2005 (JP) 2005-188874
Jun. 15, 2006 (JP) 2006-166538
Jun. 15, 2006 (JP) 2006-166544

(51) Int. Cl. F16D 13/62

(52) U.S. Cl. 192/70.12; 192/113.36

(57) ABSTRACT

A wet clutch friction plate comprises a metal plate connected to a driving side, friction material layer(s) fixed to one or both side surface(s) thereof. A discharge groove is formed on one of the friction material layers and has an inclination against the direction of rotation from the inner peripheral side toward the outer peripheral side, for discharging lubricating oil from the inner peripheral side to the outer peripheral side, and an inflow groove is formed on the same or other friction material layer to face the discharge groove to receive the lubricating oil from the outer peripheral side to the inner peripheral side. A multiple disc friction clutch apparatus fastened or released by an action of a piston, comprises a clutch drum, a clutch hub, driven plates spline-fitted on the clutch drum, and drive plates spline-fitted on the clutch hub, the drive plate being the wet clutch friction plate.

This application claims the benefit of Japanese Patent applications No. 2005-188869, No. 2005-188874, No. 2006-166538 and No. 2006-166544 which are hereby incorporated by reference.

### BACKGROUND OF THE INVENTION

1. Field of the Invention

The present invention relates to a wet clutch friction plate and a multiple disc friction clutch apparatus for prolonging the life of a clutch by effectively cooling the clutch with a small flow amount of lubricating oil when a clutch is fastened in a sliding state and in a process of torque transmission and also for expanding an environment for use of the clutch.

2. Related Background Art

A multiple disc friction clutch apparatus which is used in a starting clutch or a dual clutch transmission (DCT) is arranged to have a plurality of driven plates (SPs) and drive plates (FPs) which are alternately arranged on each other so as to be fastened or released in an action mode or a non-action mode in response to a pressing force of a piston.

In the Japanese Patent Application Laid-Open No. 2004-76896, a plurality of oil grooves each having a discharge angle for discharging oil from the inner peripheral side toward the outer peripheral side of a friction plate when the friction plate is rotated and a plurality of oil grooves each having an inflow angle for leading the oil from the outer peripheral side of the friction plate toward the inner peripheral side of the friction plate are provided on a friction plate in a mixed manner equidistantly.

That is, in the Japanese Patent Application Laid-Open No. 2004-76896, it is intended to obtain the effect of releasing and receiving lubricating oil by means of the grooves which are formed on a friction material of a friction plate disposed inside a drum.

However, though it seems that a multiple disc friction clutch apparatus disclosed in the Japanese Patent Application Laid-Open No. 2004-76896 intends to release and receive the lubricating oil by means of the grooves, it is feared that an excellent lubricating effect can not be obtained because of its cooled condition.

The present invention has been contrived taking such circumstances described above into consideration, and an object of the invention is to provide a wet clutch friction plate and a multiple disc wet friction clutch apparatus which can prolong the life of a clutch by effectively cooling the clutch with a small flow amount of lubricating oil when a clutch is fastened in a sliding state and in a process of torque transmission, expand an environment for use of the clutch, and reduce the size of a pump for lubrication since the clutch can be cooled with a small flow amount of the lubricating oil.

### SUMMARY OF THE INVENTION

In order to achieve the above object, according to a first aspect of the present invention, there is provided a wet clutch friction plate comprising a metal plate connected to a driving side and friction material layers fixed to both side surfaces thereof, and cooling means including a discharge groove which is formed on one of the friction material layers and has an inclination against the direction of rotation from the inner peripheral side toward the outer peripheral side, for discharging lubricating oil from the inner peripheral side to the outer peripheral side, and an inflow groove which is formed on the other of the friction material layers to face the discharge groove to receive the lubricating oil from the outer peripheral side to the inner peripheral side.

In a wet clutch friction plate according to the first aspect of the present invention, it is preferable that the inflow groove for receiving the lubricating oil onto the inner peripheral side has a large groove width, compared with the discharge groove having an inclination from the inner peripheral side toward the outer peripheral side.

In a wet clutch friction plate according to the first aspect of the present invention, it is preferable that the inflow groove having an inclination from the outer peripheral side toward the inner peripheral side for receiving the lubricating oil has a width which is larger on the outer peripheral side and smaller on the inner peripheral side.

In a wet clutch friction plate according to the first aspect of the present invention, it is preferable that the discharge groove for discharging the lubricating oil onto the outer peripheral side and the inflow groove for receiving the lubricating oil onto the inner peripheral side cross each other when viewed from a front or rear side of the friction plate.

In a wet clutch friction plate according to the first aspect of the present invention, it is preferable that the inflow groove has a larger groove width than the discharge groove and both the discharge groove and the inflow groove cross each other when viewed from a front or rear side of the friction plate, or the inflow groove has a width which is larger on the outer peripheral side and smaller on the inner peripheral side, and both the discharge groove and the inflow groove cross each other when viewed from a front or rear side of the friction plate.

In a wet clutch friction plate according to the first aspect of the present invention, it is preferable that the inflow groove having an inclination from the outer peripheral side toward the inner peripheral side to receive the lubricating oil is formed deeper than the discharge groove for discharging the lubricating oil to the outer peripheral side.

According to a second aspect of the present invention, there is provided a multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately disposed in the annular chamber,

wherein:
the diameter of a discharge hole of the clutch drum is not more than the sum of the thickness of the driven plate and the thickness of the drive plate; and
the number of the discharge holes in the axial direction is not more than a half that of the drive plates.

In a wet clutch friction plate according to the second aspect of the present invention, it is preferable that the discharge hole is positioned in the larger diameter portion of the spline.

In a wet clutch friction plate according to the second aspect of the present invention, it is preferable that the discharge hole is positioned in the smaller diameter portion of the spline.

In a wet clutch friction plate according to the second aspect of the present invention, it is preferable that the discharge holes are disposed at the same positions as those of the drive plates positioned at the time of fastening of the friction clutch and has a distance equivalent to one plate therebetween.

According to a third aspect of the present invention, there is provided a multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately provided in the annular chamber,

wherein:
each of the drive plates comprises a metal plate, friction material layers which are fixed to both the side surfaces thereof and cooling means which includes a discharge groove which is formed on one of the friction material layers and has an inclination against the direction of rotation from the inner peripheral side toward the outer peripheral side, for discharging lubricating oil from the inner peripheral side to the outer peripheral side and an inflow groove which is disposed to face the discharge groove on the other of the friction material layers to receive the lubricating oil from the outer peripheral side to the inner peripheral side.

According to the first and third aspects of the present invention, the clutch friction plate on the input side is arranged such that the friction material layers are fixed to both side surfaces of the metal plate, and is provided with the cooling means including the discharge groove which is formed on the friction material layer on one side surface of the friction plate and has an inclination against the direction of rotation from the inner peripheral side toward the outer peripheral side for discharging the lubricating oil from the inner peripheral side to the outer peripheral side and the inflow groove which is disposed to face the discharge groove to receive the lubricating oil from the outer peripheral side to the inner peripheral side on the friction material layer on the other side surface.

Specifically, the discharge groove and the inflow groove respectively for discharging and receiving the lubricating oil are disposed to face each other so as to be in a spread-out manner, that is, to be expanded or diverged inwardly in the radial direction, and are adapted to discharge and receive the lubricating oil on the respective surfaces, thereby exhibiting the lubrication effect. Also, the effect can be further enhanced by combining the discharge groove with the discharge hole of the drum.

Thus, according to the first and third aspects of the present invention, since the lubricating oil is discharged and received on both surfaces of the clutch friction plate on the input side, respectively, there are provided a discharge groove and an inflow groove which are optimal for the cooling operation, which are to be combined with the discharge hole of the drum, whereby the effect can be further enhanced. Moreover, it is possible to reduce the capacity of a pump for supplying the lubricating oil with the above arrangement, thereby improving the fuel efficiency.

In order to achieve the above object, according to a fourth aspect of the present invention, there is provided a wet clutch friction plate comprising:
a metal plate connected to a driving side, a friction material layer fixed to one side surface of the metal plate, and cooling mean having a discharge groove which is formed on the friction material layer and has an inclination against the direction of rotation from the inner peripheral side toward the outer peripheral side for discharging lubricating oil from the inner peripheral side to the outer peripheral side and an inflow groove which is formed on the same friction material layer to face or oppose to the discharge groove for receiving the lubricating oil from the outer peripheral side to the inner peripheral side,
wherein the cross-sectional area of the inflow groove is set to be larger than that of the discharge groove.

In a wet clutch friction plate according to the fourth aspect of the present invention, it is preferable that the inflow groove having an inclination from the outer peripheral side toward the inner peripheral side for receiving the lubricating oil has a groove width which is larger on the outer peripheral side and smaller on the inner peripheral side.

In a wet clutch friction plate according to the fourth aspect of the present invention, it is also preferable that the inflow groove having an inclination from the outer peripheral side toward the inner peripheral side for receiving the lubricating oil is formed deeper than the discharge groove for discharging the lubricating oil to the outer peripheral side.

According to a fifth aspect of the present invention, there is provided a multiple disc friction clutch apparatus in which a several number of driven plates and drive plates are alternately arranged on each other and are fastened or released in an action mode or a non-action mode in response to a pressing force of a piston,

wherein:
the drive plate is a wet clutch friction plate according to the fourth aspect described above;
the diameter of a discharge hole of the clutch drum is not more than the sum of the thickness of the driven plate and the thickness of the drive plate; and
the number of the discharge holes in the axial direction is not more than a half that of the drive plates.

In a multiple disc friction clutch apparatus according to the fifth aspect of the present invention, it is preferable that the discharge hole is positioned in the larger diameter of the spline.

In a multiple disc friction clutch apparatus according to the fifth aspect of the present invention, it is preferable that the discharge holes are positioned in the smaller diameter of the spline.

Further, in a multiple disc friction clutch apparatus according to the fifth aspect of the present invention, it is preferable that the discharge hole is disposed at the same position as that of the drive plate at the time of fastening of the friction clutch and has a distance equivalent to one plate therebetween.

According to the fourth aspect of the present invention, the cross-sectional area of the inflow groove is set to be larger than that of the discharge groove so that the grooves optimal for the cooling operation can be provided. Thus, the effect can be further enhanced by combining these grooves with the discharge hole of the drum.

With the above arrangement, the size of the pump for supplying the lubricating oil can be reduced, whereby the fuel efficiency can be improved.

As a result, it is possible to prolong the life of the clutch by effectively cooling the clutch with a small flow amount of the lubricating oil when a clutch is fastened in a sliding state and in a process of torque transmission, and also to expand an environment for use of the clutch.

### BRIEF DESCRIPTION OF THE DRAWINGS

FIG. 1 is a schematic cross-sectional view of a starting clutch unit which is provided with a multiple disc friction clutch apparatus according to an embodiment of the present invention;

FIGS. 2A to 2F are partial cut-away schematic views respectively of a drive plate which is disposed in a multiple disc friction clutch apparatus according to a first embodiment of the present invention;

FIG. 3A is a partial cross-sectional view of a multiple disc friction clutch apparatus according to the first embodiment of the present invention, and FIG. 3B is an enlarged cross-sectional view of an essential portion of the apparatus shown in FIG. 3A;

FIGS. 4A to 4F are partially cut-away schematic views of a drive plate which is disposed in a multiple disc friction clutch apparatus according to a variation of the first embodiment of the present invention;

FIG. 5 is an enlarged and partially cut-away schematic view of the drive plate shown in FIG. 4D;

FIGS. 6A and 6B are partial cross-sectional views according to a variation of a clutch drum (housing), respectively;

FIG. 7 is a schematic cross-sectional view of a starting clutch unit which is provided with a multiple disc friction clutch apparatus according to a second embodiment of the present invention;

FIG. 8 is a partially cut-away schematic view of a drive plate which is disposed in a multiple disc friction clutch apparatus according to the second embodiment of the present invention;

FIG. 9A is a partial cross-sectional views of a drive plate which is disposed in a multiple disc friction clutch apparatus according to the second embodiment of the present invention, and FIG. 9B is a partial cross-sectional view of the drive plate according to a variation of the second embodiment;

FIG. 10 is a partial cross-sectional view of a multiple disc friction clutch apparatus according to the second embodiment of the present invention;

FIGS. 11A and 11B are schematic views of a drive plate which is disposed in a multiple disc friction clutch apparatus according to a variation of the second embodiment of the present invention, respectively;

FIGS. 12A to 12D are respectively schematic views of a drive plate which is disposed in a multiple disc friction clutch apparatus according to a variation of the second embodiment of the present invention;

FIGS. 13A to 13D are respectively schematic views of a drive plate which is disposed in a multiple disc friction clutch apparatus according to a variation of the second embodiment of the present invention;

FIGS. 14A to 14D are respectively schematic views of a drive plate which is disposed in a multiple disc friction clutch apparatus according to a variation of the second embodiment of the present invention;

FIG. 15 is a schematic view of a drive plate which is disposed in a multiple disc friction clutch apparatus according to a variation of the second embodiment of the present invention; and

FIGS. 16A and 16B are respectively partial cross-sectional views according to a variation of the clutch drum (housing).

### DETAILED DESCRIPTION OF THE PREFERRED EMBDODIMENTS

A wet clutch friction plate and a multiple disc wet friction clutch apparatus according to an embodiment of the present invention will be described below with reference to the drawings.

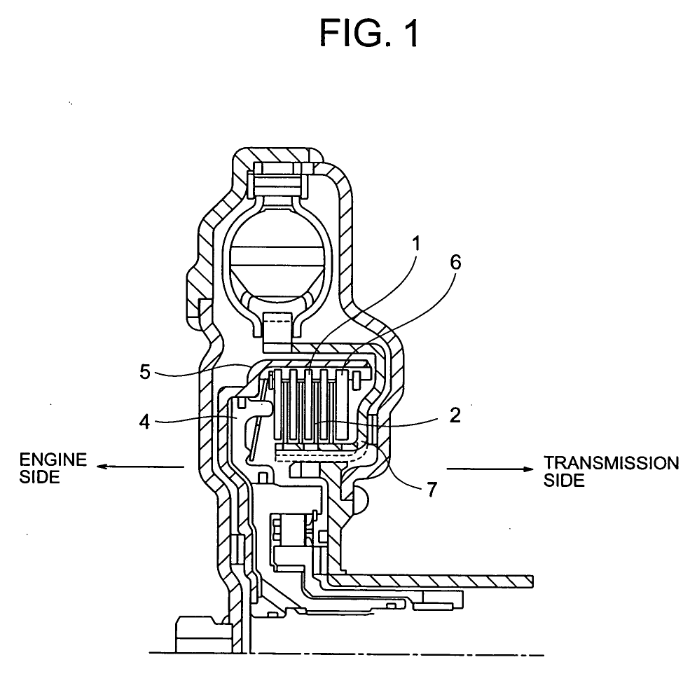

FIG. 1 is a schematic cross-sectional view of a starting clutch unit which is provided with a multiple disc friction clutch apparatus according to an embodiment of the present invention. The starting clutch unit is connected between an engine and a transmission.

In a multiple disc friction clutch apparatus, a several number of driven plates 1 (SPs) and drive plates 2 (FPs) are provided to be alternately arranged each other in an annular chamber which is formed between a clutch drum 5 connected to the transmission side and a clutch hub 7 connected to the engine side. The driven plate 1 is a metallic plate having a spline on the outer periphery thereof, which is engaged with an inner peripheral spline of the clutch drum 5 slidably in the axial direction, while the drive plate 2 is a metallic plate having a spline on the inner periphery thereof, which is engaged with an outer peripheral spline of the clutch hub 7 slidably in the axial direction. Friction material serving as facing members or linings are stuck onto both side surfaces of the drive plate 2 (FP). The driven plates 1 (SP) and the drive plates 2 (FP) are arranged such that oil pressure is supplied into a pressure chamber which is formed between the clutch drum 5 and a piston 4 to shift the piston 4 and the piston 4 slides in the axial direction due to the pressing force thereof to be pressed against a retainer plate 8 to fasten or connect the clutch. Conversely, when the oil pressure is released from the pressure chamber, the pressed state of the piston 4 is relaxed so that the clutch is released or disconnected.

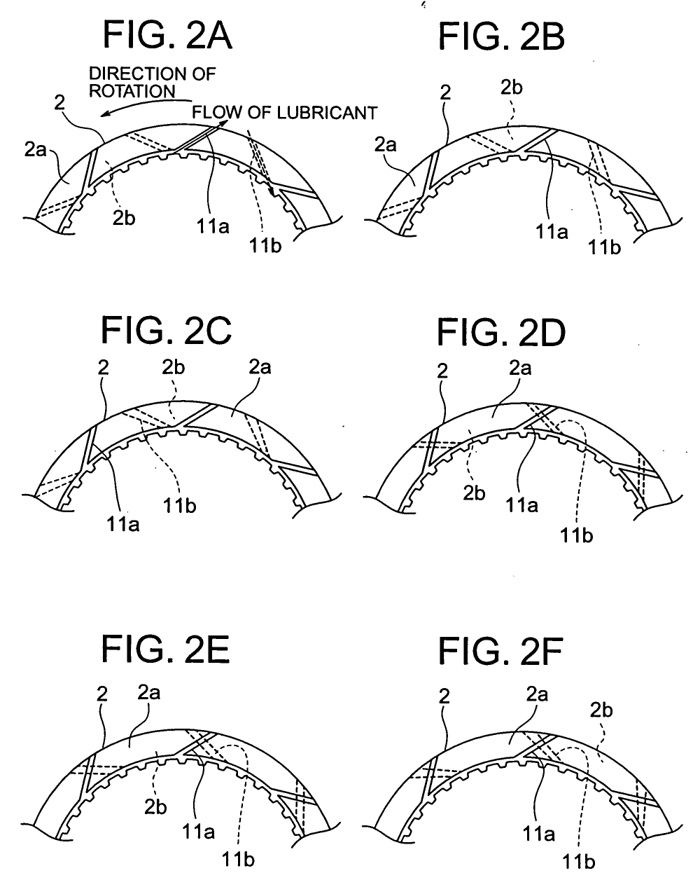

FIGS. 2A to 2F are respectively partial cut-away schematic views of a drive plate which is disposed in a multiple disc friction clutch apparatus according to a first embodiment of the present invention.

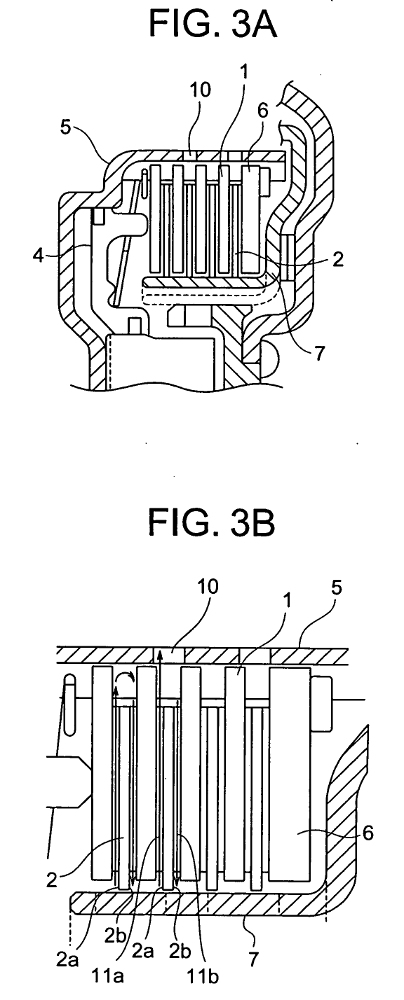

FIG. 3A is a partial cross-sectional view of a multiple disc friction clutch apparatus according to the first embodiment of the present invention, and FIG. 3B is an enlarged cross-sectional view of an essential portion of the apparatus shown in FIG. 3A.

In the present embodiment, as shown in FIG. 2A, a friction material layer which is fixed to one side surface or front side) of the drive plate 2 is formed with a discharge groove 11a which has an inclination against the direction of rotation from the inner peripheral side toward the outer peripheral side, for discharging lubricating oil from the inner peripheral side to the outer peripheral side. Also, another friction material layer fixed to the other side(rear side) surface of the drive plate 2 is formed with an inflow groove 11b which is disposed to face or oppose to the discharge groove 11a to receive the lubricating oil from the outer peripheral side to the inner peripheral side. The discharge groove 11a and the inflow groove 11b constitute cooling means.

That is, the discharge groove 11a and the inflow groove 11b for discharging and receiving the lubricating oil are disposed to face or oppose to each other so as to be expanded or diverged inwardly in the radial direction, and are adapted to discharge and receive the lubricating oil on the respective surfaces of the drive plate, thereby exhibiting the lubrication effect. Also, the effect can be further enhanced by combining the discharge groove 11a with discharge holes 10 of the clutch drum 5.

Accordingly, since the lubricating oil is discharged and received on both side surfaces of the drive plate 2, respectively, in the first embodiment, there are provided discharge grooves 11a and inflow grooves 11b which are optimal for the cooling operation, which are to be combined with the discharge holes 10 of the clutch drum 5, whereby the effect can be further enhanced. Moreover, it is possible to reduce the capacity of a pump for supplying the lubricating oil with the above arrangement, thereby improving the fuel efficiency.

In other words, the life of the clutch can be prolonged by effectively cooling the clutch with a small flow amount of the lubricating oil in the fastening of the clutch in a sliding condition and the process of torque transmission, the environment of use of the clutch can be expanded, and the size of the pump for lubrication can be reduced since the clutch can be cooled with a small flow amount of the lubricating oil.

Also, as shown in FIG. 2B, the inflow groove 11b which is adapted to receive the lubricating oil onto the inner peripheral side may have a large groove width, compared with the discharge groove 11a which has an inclination from the inner peripheral side toward the outer peripheral side.

Further, as shown in FIG. 2C, the inflow groove 11b which has an inclination from the outer peripheral side toward the inner peripheral side to receiving the lubricating oil may have a width which is larger on the outer peripheral side and a smaller on the inner peripheral side.

Further, as shown in FIG. 2D, the discharge groove 11a for discharging the lubricating oil onto the outer peripheral side and the inflow groove 11b for receiving the lubricating oil into the inner peripheral side may cross each other, when viewed from a front or rear surface side of the friction plate.

Further, as shown in FIG. 2E, the inflow groove 11b may have a larger groove width than the discharge groove 11a and both the discharge groove 11a and the inflow groove 11b may cross each other, when viewed from a front or rear surface side of the friction plate.

Further, as shown in FIG. 2F, the inflow groove 11b may have a width which is larger on the outer peripheral side and smaller on the inner peripheral side, and both the discharge groove 11a and the inflow groove 11b may cross each other, when viewed from a front or rear surface side of the friction plate.

Further, the inflow groove 11b which has an inclination from the outer peripheral side toward the inner peripheral side to receive the lubricating oil may be formed deeper than the discharge groove 11a for discharging the lubricating oil to the outer peripheral side.

As indicated by an arrow in FIG. 3B, in a place where no discharge hole 10 is provided in the clutch drum 5, the lubricating oil which flows from the inner peripheral side to the outer peripheral side along the discharge groove 11a is stagnant. On the other hand, in a place where the discharge hole 10 is provided, the lubricating oil which flows from the inner peripheral side to the outer peripheral side along the discharge groove 11a is discharged to the outside through the discharge hole 10. Also, the lubricating oil is received in the inner peripheral side from the outer peripheral side along the inlet groove 11b.

Further, as shown in FIG. 3B, the diameter of the discharge hole 10 of the clutch drum 5 is preferably not more than the sum of the thickness of the driven plate 1 and the thickness of the drive plate 2, and the number of the discharge holes 10 in the axial direction is not more than a half that of the drive plates 2.

Further, preferably, the position of the discharge hole 10 is the same as that of the drive plate 2 at the time of fastening of the friction clutch, and has a distance equivalent to one plate therefrom.

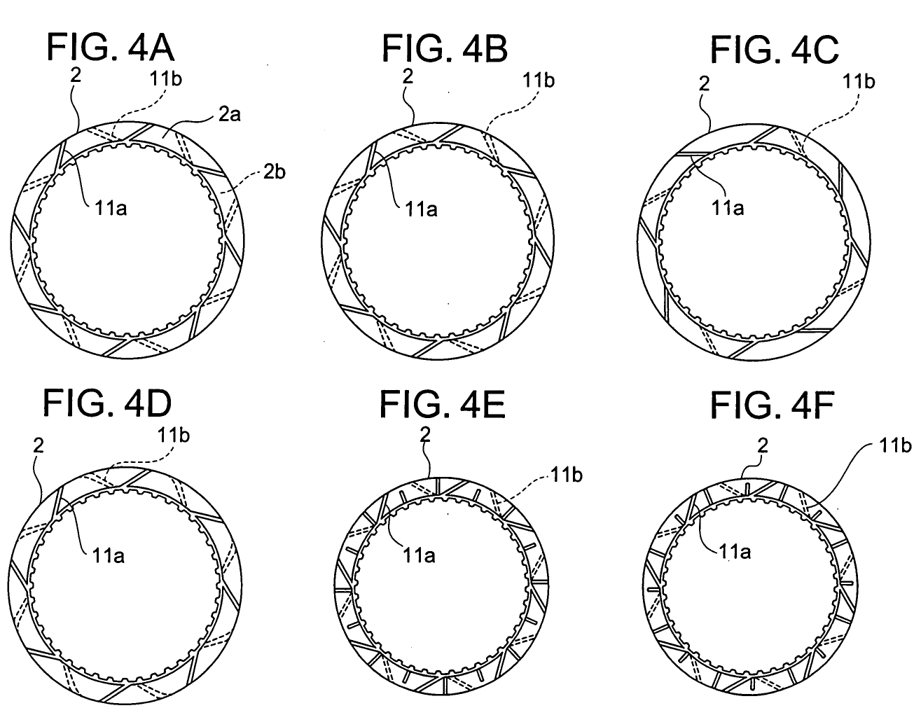

FIGS. 4A to 4F are partially cut-away schematic views of a drive plate which is attached to a multiple disc friction clutch apparatus according to a variation of the first embodiment of the present invention.

In FIG. 4A, the discharge groove 11a and the inflow groove 11b are formed to be bow shaped (arc-shaped), respectively, and the inflow groove 11b has a larger groove width than the discharge groove 11a.

In FIG. 4B, the discharge groove 11a and the inflow groove 11b are formed to be bow shaped (arc-shaped), respectively, and the inflow groove 11b has a groove width which is larger on the outer peripheral side and a smaller on the inner peripheral side.

As shown in FIG. 4C, the number of the discharge grooves 11a may be larger than that of the inflow grooves 11b.

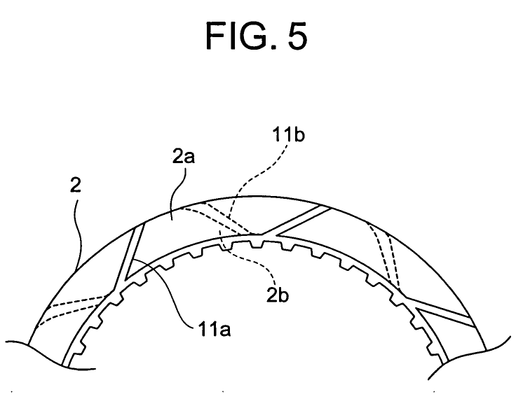

As shown in FIG. 4D, the inflow groove 11b may be formed in the rounded form so that the outer peripheral side thereof is wider. Note that FIG. 5 is an enlarged and partially cut-away schematic view of the drive plate shown in FIG. 4D.

As shown in FIG. 4E and FIG. 4F, another holes may be formed to be combined, in addition to the discharge grooves 11a and the inflow grooves 11b.

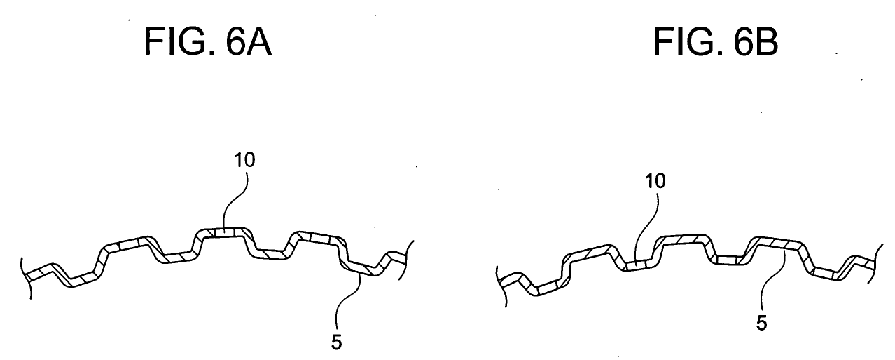

Also, FIGS. 6A and 6B are partial cross-sectional views according to a variation of the clutch drum (housing), respectively.

In an example shown in FIG. 6A, since the discharge hole 10 of the clutch drum 5 is located on the large diameter side of the spline, it is aimed of discharging the lubricating oil released to the outside through the discharge hole 10 positively.

In an example shown in FIG. 6B, since the discharge hole 10 of the clutch drum 5 is located on the small diameter side of the spline, it is aimed of arresting the lubricating oil discharged to the outside and, when the lubricating oil remaining on the large-diameter spline portion overflows into the small-diameter spline portion, passively discharging the lubricating oil through the discharge hole 10 which is located on the small-diameter spline portion.

A wet clutch friction plate and a multiple disc friction clutch apparatus according to a second embodiment of the present invention will be described below with reference to the drawings.

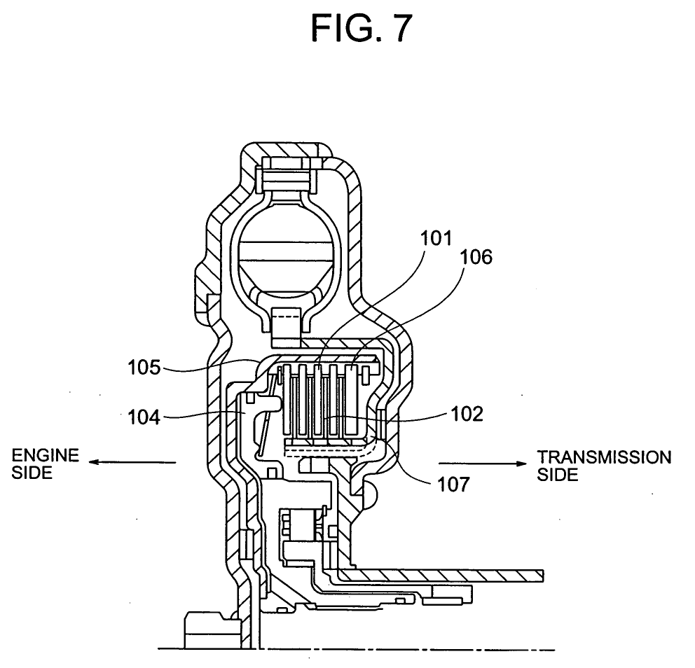

FIG. 7 is a schematic cross-sectional view of a starting clutch unit which is provided with a multiple disc friction clutch apparatus according to the second embodiment of the present invention. The starting clutch unit is connected between the engine and the transmission.

In the multiple disc friction clutch apparatus, a several number of driven plates 101 (SPs) and drive plates 102 (FPs) are provided to be alternately arranged each other in an annular chamber which is formed between a clutch drum 105 connected to the transmission side and a clutch hub 107 connected to the engine side. The driven plate 101 is a metallic plate having a spline on the outer periphery thereof, which is engaged with an inner peripheral spline of the clutch drum 105 slidably in the axial direction, while the drive plate 102 is a metallic plate having a spline on the inner periphery thereof, which is engaged with the clutch hub 7 slidably in the axial direction. It is arranged such that the friction material layers serving as facing members or linings are stuck onto both surfaces of the drive plate 102 (FPs). It may be also arranged such that the friction material layers are stuck alternately on one surface of the driven plate 101 and one surface of the drive plate 102 on the same side, respectively, as the facing members or linings. The driven plates 101 and the drive plates 102 are arranged such that oil pressure is supplied into a pressure chamber which is formed between the clutch drum 105 and a piston 104 to shift the piston 104 and the piston 104 slides in the axial direction due to the pressing force thereof to be pressed against a retainer plate 108 to fasten or connect the clutch. Conversely, when the oil pressure is released, the pressed state of the piston 104 is relaxed so that the clutch is released.

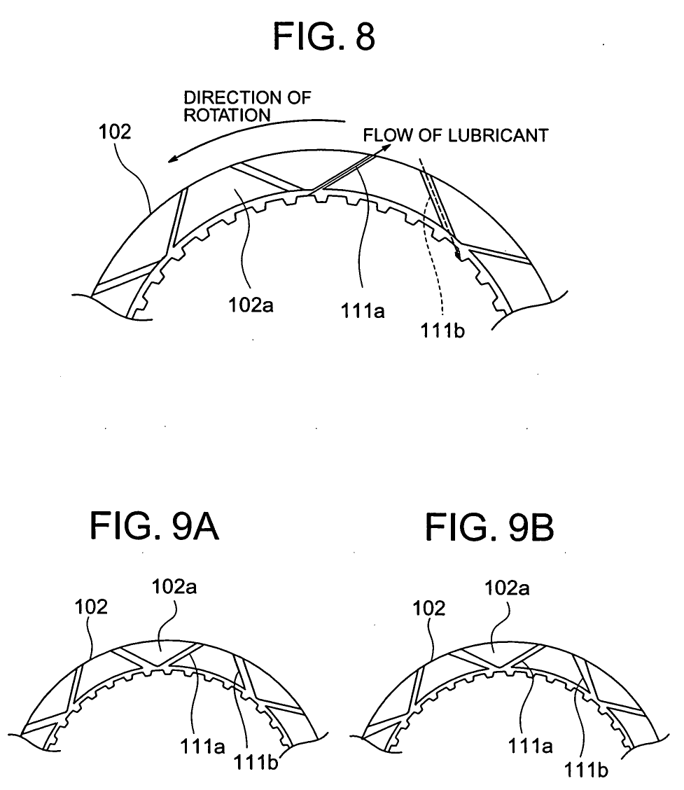

FIG. 8 is a partial cut-away schematic view of a drive plate which is disposed in a multiple disc friction clutch apparatus according to the second embodiment of the present invention.

FIG. 9A is a partial cross-sectional view of a drive plate which is disposed in a multiple disc friction clutch apparatus according to the second embodiment of the present invention, and FIG. 9B is a partial cross-sectional view of the drive plate according to a variation of the second embodiment.

FIG. 10 is a partial cross-sectional view of a multiple disc friction clutch apparatus according to the second embodiment of the present invention.

In the second embodiment, as shown in FIG. 8, the friction material layer 102a which is fixed to one side surface of the drive plate 102 is formed with a discharge groove 111a which has an inclination against the direction of rotation from the inner peripheral side toward the outer peripheral side, for discharging the lubricating oil from the inner peripheral side to the outer peripheral side. Also, an inflow groove 111b which is disposed to face or oppose to the discharge groove 111a for receiving the lubricating oil from the outer peripheral side to the inner peripheral side is provided on the same surface, that is, the same friction material layer 102a. The discharge groove 111a and the inflow groove 111b constitute cooling means.

In the second embodiment, as clearly shown in FIG. 8 and FIG. 9A, a cross-sectional area of the inflow groove 111b is set to be large, compared with that of the discharge groove 111a.

In addition, the discharge groove 111a and the inflow groove 111b for respectively discharging and receiving the lubricating oil are disposed to face or oppose to each other so as to expand or diverge inwardly in the radial direction, and are adapted to discharge and receiving the lubricating oil on the same surface, thereby exhibiting the lubrication effect.

Also, the effect can be further enhanced by combining the discharge groove 111a with an discharge hole 110 of the clutch drum 105.

Accordingly, since the lubricating oil is discharged and received on the same surface in the second embodiment, there are provided discharge grooves 111a and inflow grooves 111b optimal for the cooling operation, which are to be combined with the discharge holes 110 of the clutch drum 105, thereby further enhancing the effect. Moreover, it is possible to raise the fuel efficiency since the capacity of a pump for supplying the lubricating oil can be reduced.

In other words, it is possible to prolong the life of the clutch by effectively cooling the clutch with a small flow amount of the lubricating oil in the clutch fastening in the sliding condition and the process of torque transmission, and to expand the environment of use of the clutch, and it is also possible to reduce the size of the pump for lubrication since the clutch can be cooled with a small flow amount of the lubricating oil.

Also, as shown in FIG. 9B, the inflow groove 111b which has an inclination from the outer peripheral side toward the inner peripheral side to receive the lubricating oil may have a width which is larger on the outer peripheral side and smaller on the inner peripheral side.

Further, the inflow groove 111b which has an inclination from the outer peripheral side toward the inner peripheral side to receive the lubricating oil may be formed deeper than the discharge groove 111a for discharging the lubricating oil to the outer peripheral side.

As indicated by an arrow in FIG.10, in a place where the discharge hole 110 is provided on the clutch drum 105, the lubricating oil which flows from the inner peripheral side to the outer peripheral side along the discharge groove 111a is discharged to the outside through the discharge hole 110.

In a place where no discharge hole 110 is provided, the lubricating oil is received from the outer peripheral side to the inner peripheral side along the inflow groove 111b.

Further, as shown in FIG. 10, the diameter of the discharge hole 110 of the clutch drum 105 is preferably not more than the sum of the thickness of the driven plate 110 and the thickness of the drive plate 102, and the number of the discharge holes 110 in the axial direction is not more than a half that of the drive plates 102.

Further, preferably, the position of the discharge hole 110 is the same as that of the drive plate 102 when the friction clutch is fastened or connected, and has a distance equivalent to one plate therefrom.

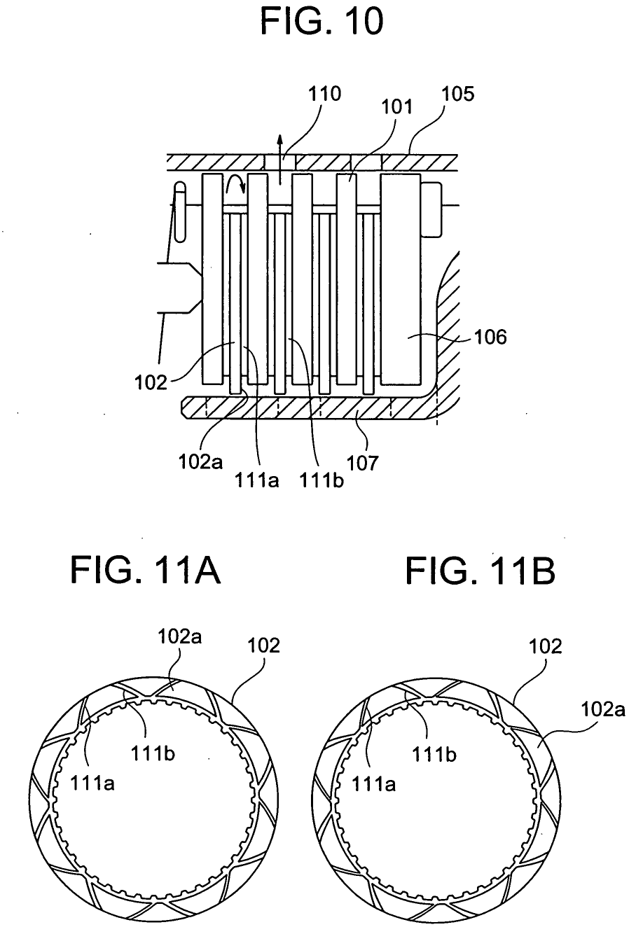

FIGS. 11A and 11B are schematic views of a drive plate which is disposed in a multiple disc friction clutch apparatus according to a variation of the second embodiment of the present invention, respectively.

First, in FIG. 11A, the discharge groove 111a and the inflow groove 111b are formed to be bow shaped (arc-shaped), respectively, and the inflow groove 111b has a larger groove width (the cross-sectional groove area) than the discharge groove 111a.

Next, in FIG. 11B, the discharge groove 111a and the inflow groove 111b are formed to be bow shaped (arc-shaped), respectively, and the inflow groove 111b has a groove width which is larger on the outer peripheral side and smaller on the inner peripheral side.

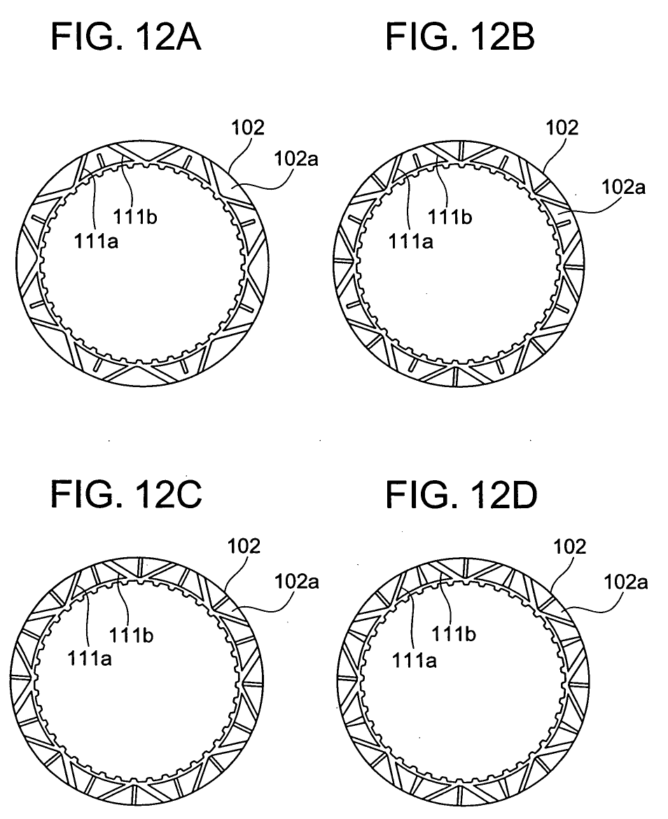

FIGS. 12A to 12D are respectively schematic views of a drive plate which is disposed in a multiple disc friction clutch apparatus according to a variation of the second embodiment of the present invention.

As shown in FIG. 12A to FIG. 12D, another hole may be formed to be combined, in addition to the discharge grooves 111a and the inflow groove 111b. Note that the inflow groove 111b has a larger groove width (the cross-sectional groove area) than the discharge groove 111a.

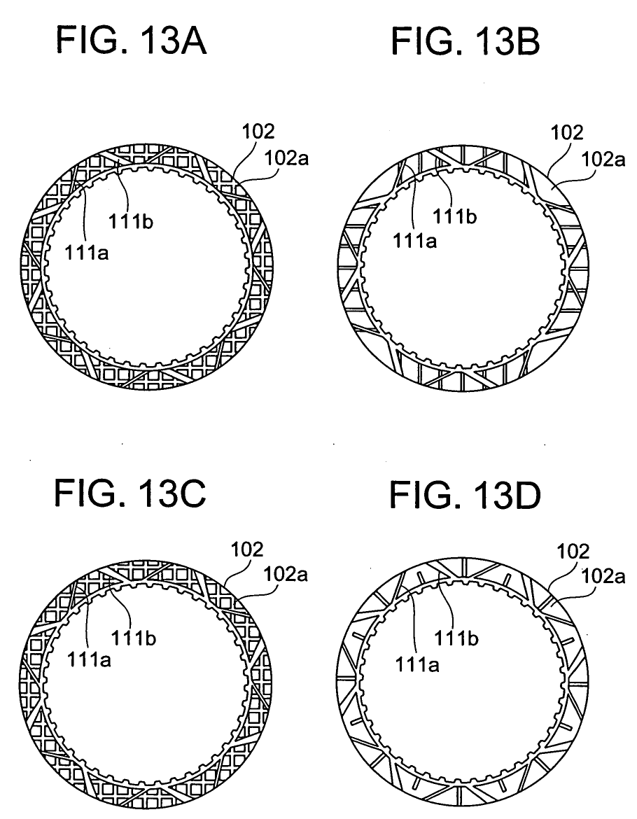

FIGS. 13A to 13D are respectively schematic views of a drive plate which is attached to a multiple disc friction clutch apparatus according to a variation of the second embodiment of the present invention.

As shown in FIG. 13A and FIG. 13B, another hole may be formed to be combined, in addition to the discharge grooves 111a and the inflow groove 111b. Note that, the inflow groove 111b has a larger groove width (the cross-sectional groove area) than the discharge groove 111a.

As shown in FIG. 13C and FIG. 13D, the inflow groove 111b may be formed to be wider on the outer peripheral side and narrower on the inner peripheral side thereof. Another hole may be formed to be combined, in addition to the discharge grooves 111a and the inflow groove 111b. Note that, the inflow groove 111b has a larger groove width (the cross-sectional groove area) than the discharge groove 111a.

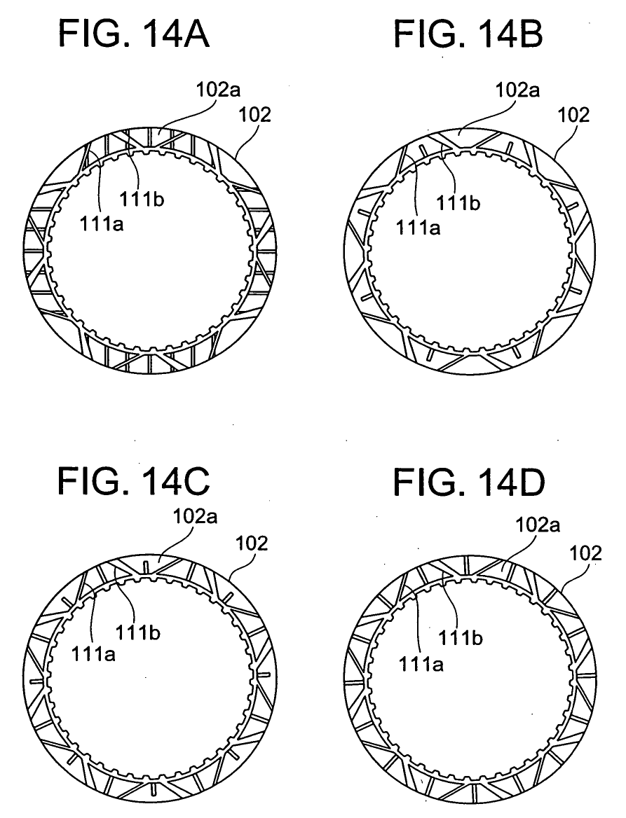

FIGS. 14A to 14D are respectively schematic views of a drive plate which is disposed in a multiple disc friction clutch apparatus according to a variation of the second embodiment of the present invention.

As shown in FIG. 14A to FIG. 14D, the inflow groove 111b may be formed to be wider on the outer peripheral side and narrower on the inner peripheral side thereof. Another hole may be formed to be combined, in addition to the discharge grooves 111a and the inflow groove 111b. Note that, the inflow groove 111b has a larger groove width (the cross-sectional groove area) than the discharge groove 111a.

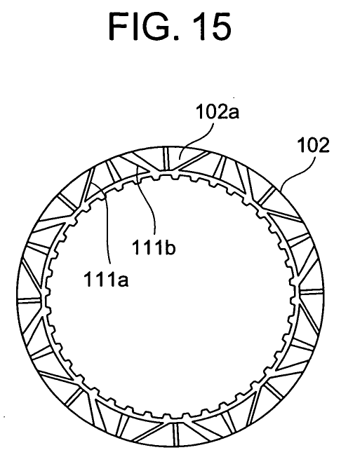

FIG. 15 is a schematic view of a drive plate which is disposed in a multiple disc friction clutch apparatus according to a variation of the second embodiment of the present invention.

As shown in FIG. 15, the inflow groove 111b may be formed to be wider on the outer peripheral side and narrower on the inner peripheral side thereof. Another hole may be formed to be combined, in addition to the discharge grooves 111a and the inflow groove 111b. Note that, the inflow groove 111b has a larger groove width (the cross-sectional groove area) than the discharge groove 111a.

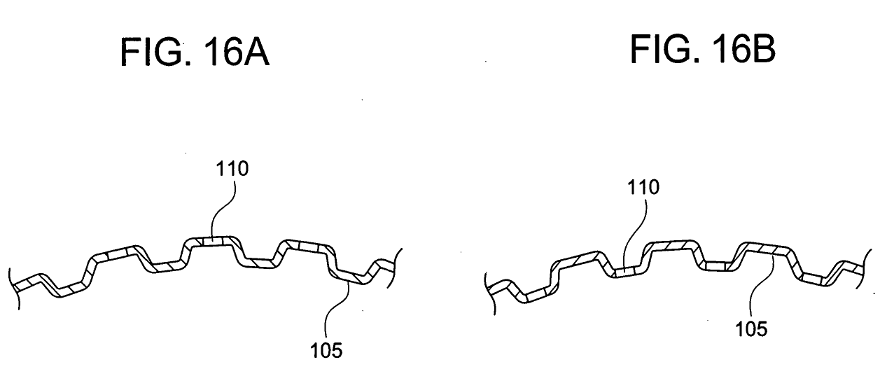

FIGS. 16A and 16B are respectively partial cross-sectional views according to a variation of the clutch drum (housing).

In an example shown in FIG. 16A, it is aimed of, since the discharge hole 110 of the clutch drum 105 is located on the large diameter side of the spline, discharging the lubricating oil released to the outside through the discharge hole 110 positively.

In an example shown in FIG. 16B, since the discharge hole 110 of the clutch drum 105 is located on the small diameter side of the spline, it is aimed of arresting the lubricating oil discharged to the outside and, when the lubricating oil remaining on the large-diameter spline portion overflows into the small-diameter spline portion, passively discharging the lubricating oil through the discharge hole 110 which is located on the small-diameter spline portion.

Note that the present invention is not limited to the foregoing embodiments, but can be altered in various manners.

1. A wet clutch friction plate comprising a metal plate connected to a driving side, friction material layers fixed to both side surfaces thereof, and cooling means including a discharge groove which is formed on one of the friction material layers and has an inclination against the direction of rotation from the inner peripheral side toward the outer peripheral side, for discharging lubricating oil from the inner peripheral side to the outer peripheral side, and an inflow groove which is formed on the other of the friction material layers to face the discharge groove to receive the lubricating oil from the outer peripheral side to the inner peripheral side.

2. A wet clutch friction plate according to claim 1, wherein said inflow groove for receiving the lubricating oil onto the inner peripheral side has a large groove width, compared with said discharge groove having an inclination from the inner peripheral side toward the outer peripheral side.

3. A wet clutch friction plate according to claim 1, wherein said inflow groove having an inclination from the outer peripheral side toward the inner peripheral side for receiving the lubricating oil has a width which is larger on the outer peripheral side and smaller on the inner peripheral side.

4. A wet clutch friction plate according to claim 1, wherein said discharge groove for discharging the lubricating oil onto the outer peripheral side and said inflow groove for receiving the lubricating oil onto the inner peripheral side cross each other, when viewed from a front or rear side of the friction plate.

5. A wet clutch friction plate according to claim 1, wherein:
said inflow groove has a larger groove width than said discharge groove and both the discharge groove and the inflow groove cross each other, when viewed from a front or rear side of the friction plate; or
said inflow groove has a width which is larger on the outer peripheral side and smaller on the inner peripheral side, and both the discharge groove and the inflow groove cross each other, when viewed from a front or rear side of the friction plate.

6. A wet clutch friction plate according to claim 1, wherein said inflow groove having an inclination from the outer peripheral side toward the inner peripheral side to receive the lubricating oil is formed deeper than said discharge groove for discharging the lubricating oil to the outer peripheral side.

7. A multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately arranged in said annular chamber,
wherein:
the diameter of a discharge hole of said clutch drum is not more than the sum of the thickness of the driven plate and the thickness of the drive plate; and the number of the discharge holes in the axial direction is not more than a half that of the drive plates.

8. A multiple disc friction clutch apparatus according to claim 7, wherein said discharge hole is positioned in the larger diameter of the spline.

9. A multiple disc friction clutch apparatus according to claim 7, wherein said discharge hole is positioned in the smaller diameter of the spline.

10. A multiple disc friction clutch apparatus according to claim 7, wherein said discharge hole is disposed at the same position as that of the drive plate positioned at the time of fastening of the friction clutch and has a distance equivalent to one plate therebetween.

11. A multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately provided in said annular chamber,
wherein:
each of the drive plates comprises a metal plate, friction material layers which are fixed to both the side surfaces thereof and cooling means which includes a discharge groove which is formed on one of the friction material layers and has an inclination against the direction of rotation from the inner peripheral side toward the outer peripheral side, for discharging lubricating oil from the inner peripheral side to the outer peripheral side and an inflow groove which is disposed to face the discharge groove on the other of the friction material layers to receive the lubricating oil from the outer peripheral side to the inner peripheral side.

12. A wet clutch friction plate comprising a metal plate connected to an input side, at least a friction material layer fixed to one surface of the metal plate, and cooling means having a discharge groove which is formed on the friction material layer and has an inclination against the direction of rotation from the inner peripheral side toward the outer peripheral side for discharging lubricating oil from the inner peripheral side to the outer peripheral side and an inflow groove which is formed on the same friction material layer and disposed to face the discharge groove for receiving the lubricating oil from the outer peripheral side to the inner peripheral side,
wherein the cross-sectional area of said inflow groove is set to be larger than that of said discharge groove.

13. A wet clutch friction plate according to claim 12, wherein said inflow groove having an inclination from the outer peripheral side toward the inner peripheral side for receiving the lubricating oil has a groove width which is larger on the outer peripheral side and smaller on the inner peripheral side.

14. A wet clutch friction plate according to claim 12, wherein said inflow groove having an inclination from the outer peripheral side toward the inner peripheral side for receiving the lubricating oil is formed deeper than said discharge groove for discharging the lubricating oil to the outer peripheral side.

15. A multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately provided in said annular chamber,
wherein:
said drive plate is a wet clutch friction plate according to claim 12;
the diameter of a discharge hole of said clutch drum is not more than the sum of the thickness of the driven plate and the thickness of the drive plate; and
the number of said discharge holes in the axial direction is not more than a half that of the drive plates.

16. A multiple disc friction clutch apparatus according to claim 15, wherein said discharge hole is positioned in the larger diameter of the spline.

17. A multiple disc friction clutch apparatus according to claim 15, wherein said discharge hole is positioned in the smaller diameter portion of the spline.

18. A multiple disc friction clutch apparatus according to claim 15, wherein said discharge hole is disposed at the same position as that of the drive plate positioned at the time of fastening of the friction clutch and has a distance equivalent to one plate therebetween.

19. A multiple disc friction clutch apparatus fastened or released by an action of a piston, comprising:
a clutch drum connected to one of an input side and an output side;
a clutch hub connected to the other of the input side and the output side and opposed to the clutch drum in the radial direction to form an annular chamber therebetween; and
driven plates spline-fitted on either the clutch drum or the clutch hub whichever is on the output side, and drive plates spline-fitted on either the clutch drum or the clutch hub whichever is on the input side, alternately provided in said annular chamber,
wherein:
said drive plate is a wet clutch friction plate according to claim 12.
